(19) United States
(12) Patent Application Publication
(10) Pub. No.: US 2003/0030358 A1
(43) Pub. Date: Feb. 13, 2003

(54) Long bulb structure

(76) Inventor: Chin-Weih Wu, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/925,455

(22) Filed: Aug. 10, 2001

(51) Int. Cl. H01K 1/18

(52) U.S. Cl. 313/316

(57) ABSTRACT

This invention relates to a long bulb structure, which includes a long glass shell being provided with two or more sunken circular areas. The inner surface of the sunken circular area may contact two conductive wires to maintain them in a right position in the glass shell and to prevent tungsten wires connected between the conductive wires from teaching the glass shell. The glass shell is thus avoided from being heated and broken and the bulb can be used in secure.

### BACKGROUND OF INVENTION

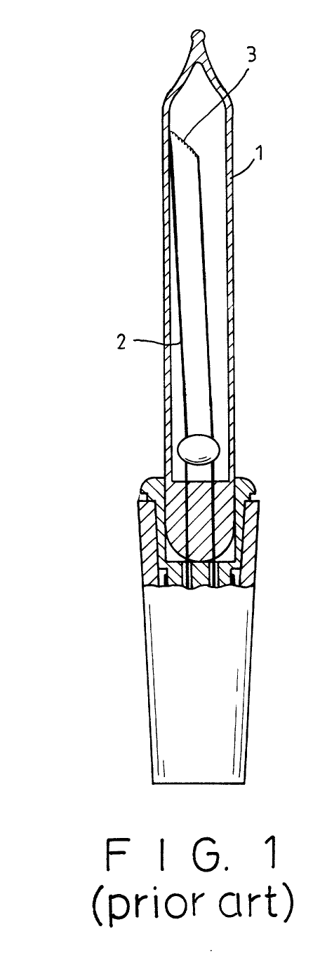

A conventional bulb has a glass shell (1) provided with two parallel conductive wires (2) inside. A tungsten wire (3) is connected with both conductive wires (2) for lighting when the conductive wires are electrical connection. In use of a long bulb structure, as shown in FIG. 1, length of the conductive wire (2) is increased. If there is any little mistake in manufacturing to lead the conductive wire being bias, the tungsten wire (3) will be very possible to contact inner wall of the glass shell (1). And when the bulb is lighting, the heat of the tungsten wire (3) may fuse the glass shell (1) and the bulb is out of work.

Accordingly, the primary object of the invention is to provide an improved long bulb structure for maintaining the conductive wires in the glass shell in right position and preventing the tungsten wire from contacting the shell. Now the features and advantages of the invention will be described in detail with reference to the accompanying drawings.

### BRIEF DESCRIPTION OF THE INVENTION

FIG. 1 is a partly cross-sectional plan view showing a prior known long bulb structure.

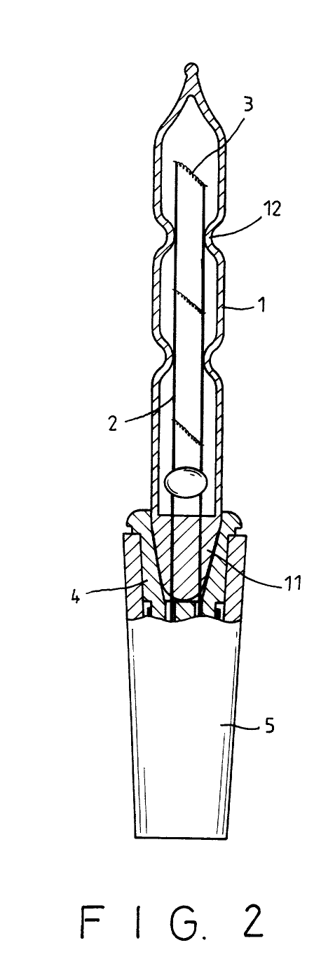

FIG. 2 is a partly cross-sectional plan view showing a long bulb structure according to the present invention.

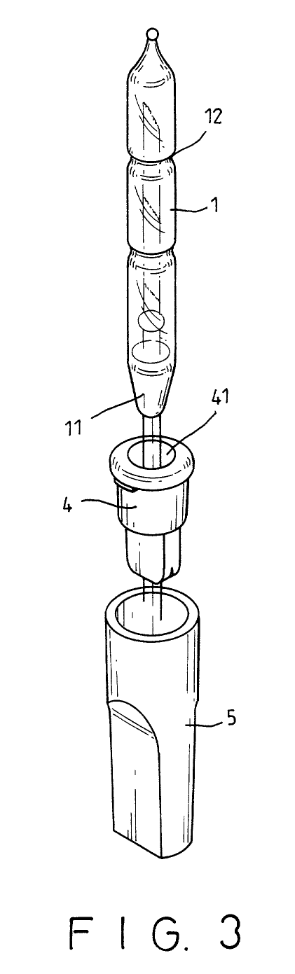

FIG. 3 is an exploded perspective view of a long bulb assembly according to the present invention.

### DETAILED DESCRIPTION OF THE INVENTION

Please refer to FIGS. 2 and 3, the present invention relates to an improved long bulb structure, which includes a glass shell (1) being provided with two sunken circular areas (12). The sunken circular area (12) can be increased and every inner surface of the area (12) can just contact the conductive wire (2) to maintain it at a right position in the glass shell (1) without any possibility of bias. Under this state, the tungsten (3) connected between the conductive wires (2) will never contact the glass shell that overcomes the drawback of a prior one.

Another characteristic of the present invention is to provide the bulb with a cone base (11) while a bulb holder (4) is provided with a related cone groove (41) and then being received in a connector (5). Since the thick of the bulb holder (4) is raised, the strength will be increased at the same time that provides a firm connection for the bulb with the bulb holder (4).

Accordingly, the invention obtains an obvious improvement and is better than a prior art. It meets the requirements of granting a patent. We hereby file an application for a patent grant.

What is claimed is:

1. A long bulb structure including a long glass shell being provided with two or more sunken circular areas, wherein the inner surface of the sunken circular area may contact two conductive wires to maintain them in a right position in the glass shell and to prevent tungsten wires provided between the conductive wires from teaching the glass shell.

2. The long bulb structure as claimed in claim 1, wherein the bulb is provided with a cone base and a bulb holder is provided with a related cone groove with a thick wall.
